(19) United States
(12) Patent Application Publication
(10) Pub. No.: US 2006/0111489 A1
(43) Pub. Date: May 25, 2006

(54) Polyoxymethylene resin molding

(75) Inventors: Hiroyuki Hase, Fuji-shi (JP); Masahiro Kada, Fuji-shi (JP)

Correspondence Address: NIXON & VANDERHYE, PC, 901 NORTH GLEBE ROAD, 11TH FLOOR, ARLINGTON, VA, 22203, US

(73) Assignee: Polyplastics Co., Ltd., Tokyo (JP)

(21) Appl. No.: 11/271,926

(22) Filed: Nov. 14, 2005

(30) Foreign Application Priority Data
Nov. 19, 2004 (JP) 2004-335353

(51) Int. Cl. C08K 5/20

(52) U.S. Cl. 524/210

(57) ABSTRACT

The present invention provides a polyoxymethylene resin molding which is used with a counterpart of a polyoxymethylene resin or a polybutylene terephthalate resin, and which has excellent friction/abrasion characteristics even in a region of high area pressure and high linear velocity. The polyoxymethylene resin molding is made of a polyoxymethylene resin composition prepared by blending a polyoxymethylene resin with (a) 0.01 to 1.0% by weight (in the composition) of a melamine resin having a particle size of 100 μm or smaller. The molding is used for a sliding component under a sliding condition (1) or (2) as follows: (1) the counterpart of sliding is a molding made of a polyoxymethylene resin, and the sliding is conducted at a PV value (area pressure×linear velocity) of 1.0 MPa·cm/s or larger; or (2) the counterpart of sliding is a molding made of a polybutylene terephthalate resin, and the sliding is conducted at a PV value (area pressure×linear velocity) of 2.0 MPa·cm/s or larger.

### TECHNICAL FIELD

The present invention relates to a polyoxymethylene resin molding which has excellent friction/abrasion characteristics under a sliding condition of high area pressure and high linear velocity.

### BACKGROUND ART

A polyoxymethylene resin is one of engineering plastics having excellent mechanical strength and friction/abrasion characteristics and used in various fields including electric/electronic mechanical parts, automobile parts or the like. Such fields, however, request the resin to have even higher characteristics, including a high level of compatibility between slidability, molding appearance, and mechanical strength. Particularly, the resin is requested to have further improved slidability under a condition of a small contact area of the slide section (in other words, higher area pressure at the slide section) with a large linear velocity in the slide area.

In order to improve the slidability, the polyoxymethylene resin is mixed with a fluororesin, a polyolefin-based resin, or a lubricating oil such as a fatty acid ester or a silicone oil.

JP-A-3-111446 discloses that a polyoxymethylene resin is supplied with a specific graft copolymer, further in combination with a lubricant and an inorganic powder added, to improve friction/abrasion characteristics and prevent the molding against peeling in the surface.

### DISCLOSURE OF THE INVENTION

The fluororesin or the polyolefin-based resin, indeed, is efficiently added to improve slidability, but is poor in compatibility with the polyoxymethylene resin, resulting in the peeling of the molding in the surface or lowering of the mechanical strength.

In order to improve the slidability of the polyoxymethylene resin, a large amount of lubricating oil such as a fatty acid ester or a silicone oil must be added, resulting in reduction in mechanical properties of a resin composition obtained and exudation of the lubricating oil at usage.

The method, where a polyoxymethylene resin is supplied with a specific graft copolymer, further in combination with a lubricant and an inorganic powder added, does not completely solve the problems of peeled molding in the surface or lowered mechanical properties.

The present inventors carried out detail studies on slidability to solve the above problems. As a result, the inventors have found that a polyoxymethylene resin can be supplied with a specific melamine resin to get excellent friction/abrasion characteristics particularly in a region of high area pressure and high linear velocity, thereby providing the polyoxymethylene resin molding which is free from peeling in the surface and has balanced performances in balance among mechanical properties. The finding has completed the present invention.

Namely, the present invention provides a polyoxymethylene resin molding comprising a polyoxymethylene resin composition prepared by blending a polyoxymethylene resin with (a) 0.01 to 1.0% by weight (in the composition) of a melamine resin having a particle size of 100 μm or smaller, which molding being used for a sliding component under a sliding condition (1) or (2) as follows:
(1) the counterpart of sliding being a molding made of a polyoxymethylene resin, and the sliding being conducted at a PV value (area pressure×linear velocity) of 1.0 MPa·cm/s or larger.
(2) the counterpart of sliding being a molding made of a polybutylene terephthalate resin, and the sliding being conducted at a PV value (area pressure×linear velocity) of 2.0 MPa·cm/s or larger.

### DETAILED EXPLANATION OF THE INVENTION

The present invention will be described in detail below. As described above, the present invention is a molding which comprises a resin composition prepared by blending a polyoxymethylene resin with (a) 0.01 to 1.0% by weight (in the composition) of a melamine resin having a particle size of 100 μm or smaller and is characterized by being used under a specifically limited sliding condition.

The specifically limited sliding condition is referred to a condition: the counterpart of sliding being a molding made of a polyoxymethylene resin or a molding made of a polybutylene terephthalate resin, and the sliding being conducted at a PV value (area pressureμlinear velocity) of 1.0MPa·cm/s or larger if the counterpart of sliding is a molding made of a polyoxymethylene resin, or at a PV value of 2.0MPa·cm/s or larger if that is a molding made of a polybutylene terephthalate resin.

The molding comprising the resin composition of the present invention can exhibit remarkable slidability for the sliding at such a high PV value with a specific counterpart. The different PV values adaptable depending on the resin materials of their respective counterparts can be considered to assign to the properties of the resins (including melting point, softening point, and changes in viscosity/adhesion of resin due to rise in temperature by heat generation caused by sliding).

The polyoxymethylene resin used according to the present invention is a polymer which has an oxymethylene group (—CH₂O—) as the main structural unit. The polymer may be any of a polyoxymethylene homopolymer, a polyoxymethylene copolymer containing a small amount of a structural unit other than the oxymethylene group, a polyoxymethylene terpolymer, and a block polyoxymethylene copolymer, and a molecule may have a branch or crosslink as well as linear structure. The polymer is not particularly limited in polymerization degree.

The melamine resin used according to the present invention is a product fundamentally obtained by the polycondensation of melamine and formaldehyde, may be soluble or insoluble in water, and may be structured in net working. Less than 50 mol % of the melamine may be substituted with the other condensable substance such as dicyan diamide and benzoguanamine. The resin is preferably insoluble in hot water and has an average polymerization degree of 2 or more.

The melamine resin used according to the present invention can be produced by a known method. Melamine is added in an aqueous solution of formaldehyde, adjusted to have a pH of 8 to 9, and then stirred at a temperature maintained at 60-90° C. to dissolve and to cause reaction, when a solution becomes white turbid due to accelerated reaction, which is then cooled in for appropriate time to stop the condensation, dried by a method such as spray drying, pulverized if necessary, and sieved to get the melamine resin (a melamine-formaldehyde polycondensate) having a desired particle size.

It is essential that the melamine resin used according to the present invention has a particle size of 100 μm or smaller. A melamine resin having a particle size of larger than 100 μm is not desirable since reduction in mechanical properties and deterioration of appearance of molding surface are caused.

The melamine resin (a) added according to the present invention has a content of 0.01 to 1.0% by weight in the polyoxymethylene resin composition, and preferably 0.05 to 0.5% by weight. If the amount of addition is very low, sufficient effects are not obtained and if excessive, reduction in mechanical properties and deterioration of molding surface appearance are caused, which are not desirable.

A steric hindrance phenol-base antioxidant (b) is preferably added in the composition used in the present invention in order to improve the heat stability. The steric hindrance phenol-base antioxidant (b) includes: 2,2′-methylene bis(4-methyl-6-t-butylphenol, 1,6-hexanediol-bis[3-(3,5-di-t-butyl-4-hydroxyphenyl)propionate], pentaerythritol tetrakis[3-(3,5-di-t-butyl-4-hydroxyphenyl)propionate, triethyleneglycol-bis[3-(3-t-butyl-5-methyl-4-hydroxyphenyl)propionate, 1,3,5-trimethyl-2,4,6-tris(3,5-di-t-butyl-4-hydroxybenzyl)-benzene, n-octadecyl-3-(4′-hydroxy-3′,5′-di-t-butylphenol)-propionate, 4,4′-methylenebis(2,6-di-t-butylphenol), 4,4′-butylidene bis(6-t-butyl-3-methyl-phenol), di-stearyl-3,5-di-t-butyl-4-hydroxybenzyl phosphonate, 2-t-butyl-6-(3-t-butyl-5-methyl-2-hydroxybenzyl)-4-methylphenyl acrylate, and N,N′-hexamethylene bis(3,5-di-t-butyl-4-hydroxy-hydrocinnamide. The steric hindrance phenol-base antioxidant (b) has a content of 0.01 to 3.0% by weight in the polyoxymethylene resin composition, and preferably 0.05 to 1.0% by weight. If the amount of addition is very low, sufficient effects are not obtained and if excessive, heat stability effects are saturated, resulting in coloring tendency instead, which is not desirable.

Any one or more of (c) a lubricant selected from a fatty acid amide and a fatty acid ester, (d) a nitrogen-containing compound having reactivity with formaldehyde, and (e) a metal-containing compound is preferably added in the composition used in the present invention.

The (c) fatty acid amide used in the present invention is derived from at least one saturated or unsaturated fatty acid containing preferably 10 or more carbon atoms and an amine or a diamine. The (c) fatty acid ester is derived from at least one saturated or unsaturated fatty acid containing preferably 10 or more carbon atoms and an alcohol. The fatty acid for providing the fatty acid amide or the fatty acid ester includes: lauric acid, myristic acid, palmitic acid, stearic acid, behenic acid, montanic acid, and oleic acid. The alcohol for providing the fatty acid ester includes a polyhydric alcohol such as ethylene glycol, propylene glycol, glycerin, or pentaerythritol, and a monohydric alcohol such as propyl alcohol, butyl alcohol, lauryl alcohol, myristyl alcohol, palmityl alcohol, stearyl alcohol or behenyl alcohol. The particularly preferable example of (c) the fatty acid amide and the fatty acid ester includes ethylene bisstearylamide and glycerin monostearate. (c) the fatty acid amide and the fatty acid ester added in the present invention have a content of 0.01 to 10.0% by weight in the polyoxymethylene resin composition, and preferably 0.1 to 5.0% by weight.

(d) the nitrogen-containing compound having reactivity with formaldehyde includes, but is not limited to, the following substances: a guanamine compound (such as melamine, benzoguanamine, cyanoguanidine, and CTU guanamine), a hydrazide compound (such as adipic acid dihydrazide, sebacic acid dihydrazide, and naphthalic acid dihydrazide), a polyamide (for example, a mono- or co-polymerized polyamide such as nylon 3, nylon 12, nylon 6/10, nylon 6/66/610, nylon 6/66/610/612, a substituted polyamide having methylol group for example, and a polyesteramide synthesized from a nylon salt and caprolactam, or synthesized from the combinations of caprolactone and caprolactam), a polyaminotriazol, a dicarboxylic acid hydrazide, a heat condensate synthesized by heating from urea, a nitrogen-containing polycondensate synthesized from urea and a diamine, a urea heat condensate synthesized by heating urea, and a polycondensate from a cyanoguanidine and formaldehyde. (d) the nitrogen-containing compound having reactivity with formaldehyde added in the present invention has a content of 0.01 to 1.0% by weight in the polyoxymethylene resin composition.

(e) The metal-containing compound includes: the hydroxide of an alkali or earth-alkali metal, the carboxylic acid salt of an alkali or earth-alkali metal, the oxide of an alkali or earth-alkali metal, and the carbonic acid salt of an alkali or earth-alkali metal. The specific example includes, but is not limited to, magnesium hydroxide, calcium hydroxide, calcium stearate, calcium 12-hydroxystearate, calcium citrate, magnesium oxide, calcium oxide, calcium carbonate, and magnesium carbonate. (e) the metal-containing compound added in the present invention has a content of 0.01 to 1.0% by weight in the polyoxymethylene resin composition.

One or more of various known additives may be added in the polyoxymethylene resin composition used according to the present invention in order to provide the composition with desired performances depending on the objects. The additives include colorants, molding-release agents, cores, anti-electrostatics, weather (light) resistant stabilizer, surfactants, and polymers. Further, one or more of known organic, inorganic, or metallic fillers being in forms such as fibers, plates, and particles may be added as far as they give no bad effect on the object of the present invention. The inorganic fillers include, but are not limited to, glass fibers, kalium titanate fibers, glass beads, talc, mica, white mica, and wollastonite.

The polyoxymethylene resin composition according to the present invention is easily prepared by a conventionally known method commonly used for preparing a resin composition. The method includes: a method wherein components are mixed together, kneaded and extruded through a single screw extruder or a twin screw extruder to prepare a pellet; a method wherein pellets having different compositions are prepared, mixed at a specified rate (dilution), and molded to provide a molding with a desired composition; and a method wherein one or more of components are directly charged into a molding machine. Any of them can be used in the present invention. A method wherein the polyoxymethylene resin as the base component is partly or wholly pulverized, mixed with the other components, and extruded is preferred to improve the dispersibility of additives.

In the present invention, the counterpart of sliding is a molding made of a polyoxymethylene resin or a molding made of a polybutylene terephthalate resin. The polyoxymethylene resin of a molding as the counterpart may have compositions which are same to or different from those as described herein. The polybutylene terephthalate resin of a molding as the counterpart also is not particularly limited. Various widely used polybutylene terephthalate resin and the composition thereof can be used for the present invention.

The polyoxymethylene resin molding of the present invention is a favorite molding which is remarkably improved in friction/abrasion characteristics particularly in a region of high area pressure and high linear velocity.

### EXAMPLE

The present invention will be described in more detail with reference to Examples. The present invention, however, is not limited to the Examples. The evaluation methods used in Examples are as follows.

<Specific Abrasion Loss>

Specific abrasion loss was determined by the Suzuki Friction/Abrasion Tester at an atmospheric temperature of 23° C. under the conditions of PV values (area pressure×linear velocity) listed in Table 1. The materials for the counterparts were the polyoxymethylene resin and ordinary polybutylene terephthalate resin (made by Polyplastics Co., Ltd. trade name: Geranex2002).

TABLE 1

| PV value (MPa · cm/s) | Area pressure (MPa) | Linear velocity (cm/s) |
|---|---|---|
| 0.9 | 0.06 | 15 |
| 1.8 | 0.06 | 30 |
| 2.4 | 0.04 | 60 |

<Appearance of Molding Surface>

A center pin gate 50 mm×50 mm×2 mm t plate test piece was molded under a condition: cylinder temperature 190° C., injection pressure 74 MPa, and injection speed 3 m/min. The appearance (peering, jetting, surface roughening) of the molding thus obtained was visually observed to rank by levels as follows: (good) 5-4-3-2-1 (bad)

### Examples 1 to 9

The polyoxymethylene resin copolymer (made by Polyplastics Co., Ltd., Duracon® M270) was supplied with (a) a melamine resin having an average particle size of 100 μm or smaller, (b) a steric hindrance phenol-base antioxidant, (c) a fatty acid amide or a fatty acid ester, (d) a nitrogen-containing compound having reactivity with formaldehyde, and (e) a metal-containing compound at their different rates listed in Table 2 to mix, and extruded at a resin temperature of 200° C. by a twin screw extruder to provide pellet compositions, which were evaluated as described above. The results are shown in Table 2.

### Comparative Examples 1 to 5

Pellet compositions for comparison were prepared in the same manner as in above Examples, provided that (a) the melamin resin specified according to the present invention, for example, was not supplied to mix. The pellet compositions were evaluated as described above. The results are shown in Table 3. Pellet compositions were prepared likewise, provided that the fatty acid amide or the fatty acid ester was not supplied to mix. They were not favorable because mold releasing characteristics were poor, resulting in difficulty in molding.

Details of (a) a melamine resin, (b) a steric hindrance phenol-base antioxidant, (c) a fatty acid amide or a fatty acid ester, (d) a nitrogen-containing compound having reactivity with formaldehyde, and (e) a metal-containing compound used in Examples and Comparative Examples, and the other compounds used in Comparative Examples, are as follows:

<The Melamine Resin Specified According to the Present Invention>

The Melamine Resin Having a Particle Size of 100 μm or Smaller

1.2 mol of formaldehyde was reacted with 1 mol of melamine in an aqueous solution at pH 8 at 70° C. with the reaction system avoided from being turbid to produce the water-soluble early-condensed product of a melamine-formaldehyde resin. Then, the reaction system was adjusted under stirring to have a pH of 6.5, and kept under stirring to deposit the melamine-formaldehyde resin, which was then dried to provide the powdery particle of the crude melamine-formaldehyde resin. The powdery particle was washed with 60° C. hot water for 30 min, and filtered to get a residue, which was washed with acetone and dried to obtain the white powder of the purified melamine-formaldehyde resin. The powder was sieved to provide the melamine resin having a particle size of 100 μm or smaller (an average particle size of 14 μm).

<The Melamine Resin Having a Particle Size of 120 μm or Larger>

1.2 mol of formaldehyde was reacted with 1 mol of melamine in an aqueous solution at pH 8 at 70° C. with the reaction system avoided from being turbid to produce the water-soluble early-condensed product of a melamine-formaldehyde resin. Then, the reaction system was adjusted under stirring to have a pH of 6.5, and kept under stirring to deposit the melamine-formaldehyde resin, which was then dried to provide the powdery particle of the crude melamine-formaldehyde resin. The powdery particle was washed with 60° C. hot water for 30 min, and filtered to get a residue, which was washed with acetone and dried to obtain the white powder of the purified melamine-formaldehyde resin. The powder was sieved to provide the melamine resin having a particle size of 120 μm or larger.

(b) Steric Hindrance Phenol Base Antioxidant

b-1: pentaerythritol

tetrakis[3-(3,5-di-t-butyl-4-hydroxy-phenyl)propionate]

b-2: triethylene glycol

bis[3-(3-t-butyl-5-methyl-4-hydroxy-phenyl)propionate]

(c) Fatty Acid Amide and Fatty Acid Ester

c-1: glycerin monostearate

c-2: ethylene bis-stearic acid amide

c-3: glycerin monobehenate

(d) Nitrogen-Containing Compound Having Reactivity with Formaldehyde

d-1: benzoguanamine

d-2: sebacic acid dihydrazide

(e) Metal-Containing Compound

e-1: 12-hydroxystearic acid calcium

The Other Additive

Melamine: 99% or more having a particle size of 100 μm or smaller.

Talc: 99% or more having a particle size of 100 μm or smaller (an average particle size of 3 μm).

PE-g-AN/S: obtained by graft-copolymerizing an acrylonitrile-stylene copolymer to a polyethylene.

| | | | Examples | | | | | | | | |
|---|---|---|---|---|---|---|---|---|---|---|---|
| | | | 1 | 2 | 3 | 4 | 5 | 6 | 7 | 8 | 9 |
| Polyoxymethylene resin (parts by weight) | | | 100 | 100 | 100 | 100 | 100 | 100 | 100 | 100 | 100 |
| Melamine resin having a particle size of 100 μm or smaller | | | 0.05 | 0.10 | 0.10 | 0.15 | 0.20 | 0.15 | 0.15 | 0.15 | 0.15 |
| (parts by weight) | | | | | | | | | | | |
| Steric hindrance phenol-base antioxidant b-1 (parts by weight) | | | 0.3 | | 0.3 | 0.3 | 0.3 | 0.3 | 0.3 | 0.3 | 0.3 |
| Steric hindrance phenol-base antioxidant b-2 (parts by weight) | | | | 0.30 | | | | | | | |
| Fatty acid ester c-1 (parts by weight) | | | 0.25 | 0.25 | 0.25 | 0.25 | 0.25 | 0.2 | | | |
| Fatty acid amide c-2 (parts by weight) | | | | | | | | 0.05 | 0.25 | 0.25 | 0.25 |
| Nitrogen-containing compound d-1 (parts by weight) | | | | | | | | | | 0.5 | |
| Nitrogen-containing compound d-2 (parts by weight) | | | | | | | | | | | 0.1 |
| Metal-containing compound e-1 (parts by weight) | | | | | | | | | | 0.1 | |
| Appearance of molding | | | 5 | 5 | 5 | 5 | 4 | 5 | 5 | 5 | 5 |
| Specific abrasion | to same | PV value = 0.9 (MPa · cm/s) | 106 | 98 | 106 | 92 | 101 | 104 | 100 | 95 | 95 |
| (×10⁻³mm³/(N · m)) | material | PV value = 1.8 (MPa · cm/s) | 699 | 741 | 301 | 325 | 259 | 259 | 350 | 250 | 250 |
| | to PBT | PV value = 1.8 (MPa · cm/s) | 4 | 4 | 5 | 5 | 5 | 4 | 4 | 4 | 5 |
| | | PV value = 2.4 (MPa · cm/s) | 9 | 9 | 8 | 8 | 7 | 7 | 8 | 7 | 8 |

| | | | Comparative Examples | | | | |
|---|---|---|---|---|---|---|---|
| | | | 1 | 2 | 3 | 4 | 5 |
| Polyoxymethylene resin (parts by weight) | | | 100 | 100 | 100 | 100 | 100 |
| Melamine resin having a particle size of 120 μm or larger (parts by weight) | | | | | 0.1 | | |
| Steric hindrance phenol-base antioxidant b-1 (parts by weight) | | | 0.3 | 0.3 | 0.3 | 0.3 | 0.3 |
| Fatty acid ester c-1 (parts by weight) | | | 0.25 | 0.25 | 0.25 | | |
| Fatty acid amide c-2 (parts by weight) | | | | | | 0.25 | |
| Fatty acid ester c-3 (parts by weight) | | | | | | | 5 |
| Talc (parts by weight) | | | | 0.10 | | | 5 |
| Melamine (parts by weight) | | | | | | 0.05 | |
| PE-g-AN/S (parts by weight) | | | | | | | 10 |
| Appearance of molding | | | 5 | 5 | 1 | 5 | 2 |
| Specific abrasion | to same | PV value = 0.9 (MPa · cm/s) | 89 | 98 | 89 | 68 | 10 |
| (×10⁻³mm³/(N · m)) | material | PV value = 1.8 (MPa · cm/s) | 1426 | 1148 | 700 | 986 | 12 |
| | to PBT | PV value = 1.8 (MPa · cm/s) | 5 | 5 | 5 | 4 | 3 |
| | | PV value = 2.4 (MPa · cm/s) | 16 | 14 | 16 | 12 | 6 |

It is revealed from the results of Table 2 and 3 that, when a molding slides with a molding counterpart made of a polyoxymethylene resin at a PV value of less than 1.0 MPa·cm/s or with a molding counterpart made of a polybutylene terephthalate resin at a PV value of less than 2.0 MPa·cm/s, the molding of Comparative Example has a remarkably increasing specific abrasion loss beyond a certain PV value though it has often a little specific abrasion loss (equal to Example) and is not suitable for practical use, while the molding of the present invention is excellent in friction/abrasion characteristics even in a region of high area pressure and high linear velocity.

1. A polyoxymethylene resin molding comprising a polyoxymethylene resin composition prepared by blending a polyoxymethylene resin with (a) 0.01 to 1.0% by weight (in the composition) of a melamine resin having a particle size of 100 μm or smaller, which molding being used for a sliding component under a sliding condition (1) as follows:
(1) the counterpart of sliding being a molding made of a polyoxymethylene resin, and the sliding being conducted at a PV value (area pressure×linear velocity) of 1.0 MPa·cm/s or larger.

2. A polyoxymethylene resin molding comprising a polyoxymethylene resin composition prepared by blending a polyoxymethylene resin with (a) 0.01 to 1.0% by weight (in the composition) of a melamine resin having a particle size of 100 μm or smaller, which molding being used for a sliding component under a sliding condition (2) as follows:
(2) the counterpart of sliding being a molding made of a polybutylene terephthalate resin, and the sliding being conducted at a PV value (area pressure×linear velocity) of 2.0 MPa·cm/s or larger.

3. The polyoxymethylene resin molding as in claim 1, wherein the polyoxymethylene resin composition further comprises (b) 0.01 to 3.0% by weight (in the composition) of a steric hindrance phenol-based antioxidant.

4. The polyoxymethylene resin molding as claim 1, wherein the polyoxymethylene resin composition further comprises one or more of (c) 0.05 to 10.0% by weight of a lubricant selected from a fatty acid amide and a fatty acid ester, (d) 0.01 to 1.0% by weight of a nitrogen-containing compound having reactivity with formaldehyde, and (e) 0.01 to 1.0% by weight of a metal-containing compound (in the composition, respectively).

5. The polyoxymethylene resin molding as in claim 2, wherein the polyoxymethylene resin composition further comprises (b) 0.01 to 3.0% by weight (in the composition) of a steric hindrance phenol-based antioxidant.

6. The polyoxymethylene resin molding as in claim 2, wherein the polyoxymethylene resin composition further comprises one or more of (c) 0.05 to 10.0% by weight of a lubricant selected from a fatty acid amide and a fatty acid ester, (d) 0.01 to 1.0% by weight of a nitrogen-containing compound having reactivity with formaldehyde, and (e) 0.01 to 1.0% by weight of a metal-containing compound (in the composition, respectively).

7. The polyoxymethylene resin molding as in claim 3, wherein the polyoxymethylene resin composition further comprises one or more of (c) 0.05 to 10.0% by weight of a lubricant selected from a fatty acid amide and a fatty acid ester, (d) 0.01 to 1.0% by weight of a nitrogen-containing compound having reactivity with formaldehyde, and (e) 0.01 to 1.0% by weight of a metal-containing compound (in the composition, respectively).
